(19) United States
(12) Patent Application Publication
(10) Pub. No.: US 2002/0134150 A1
(43) Pub. Date: Sep. 26, 2002

(54) Automatic car tire pressure detecting apparatus

(76) Inventor: Shih-Pin Shih, Taipei (TW)

Correspondence Address: BACON & THOMAS, PLLC, 4th Floor, 625 Slaters Lane, Alexandria, VA, 22314-1176, US

(21) Appl. No.: 09/813,788

(22) Filed: Mar. 22, 2001

(51) Int. Cl. B60C 23/02

(52) U.S. Cl. 73/146.2

(57) ABSTRACT

An automatic car tire pressure detecting apparatus constitutes an emission means located at the wheel rim of the tire and a receiving means located at the brake pad. The emission means includes a generator, an emission end and a pressure sensor. The generator has a coil which has a positive and a negative end linked in series with a rectify switch and the emission end. The receiving means includes a magnet located at a corresponding tangent spot of the coil, a receiving end and a microprocessor attached to a display device. When the tire rotates, the magnet continuously cuts the coil to generate electric current to actuate the emission end. The rectify switch determines if the current flowing therethrough is positive. The positive current will be used for actuating the emission end to emit signals which are received by the receiving end thereby the detecting apparatus is able to provide self-generating power supply to transmit signals without an external power supply.

### BACKGROUND OF THE INVENTION

This invention relates to an automatic car tire pressure detecting apparatus and particularly a tire pressure detecting apparatus that has self generating power supply and is capable to function without external electric power supply for transmitting signals.

Automobiles is a widely used transportation means for people living in modern time. With a great number of cars on the road, driving safety is an important issue to the drivers. One of the critical factors for safety driving of car is the tire. Not proper tire pressure could cause serious wearing of-tire treads and result in bursting of the tire during driving. In order to improve the driving safety, there are tire pressure detecting devices being developed. Conventional tire pressure detecting devices usually are mounted on the inflation valve of the tire. They have a two-color warning bolt located in a tire pressure cap to indicate if the tire pressure is adequate. However the tire pressure cap is not visible to the driver when the car is moving. Only when the car is stop can the driver sees the tire pressure cap and check the tire pressure. During driving, the driver does not know the tire pressure condition. It becomes a safety concern.

To improve the situation, there is a wireless co-sensing and co-vibrating tire pressure detecting device being developed. It mainly includes a tire pressure sensor installed inside the tire and has an actuator located at the car chassis closed to the tire. In the car, there is a control apparatus which includes a detection unit, a central processing unit and an indication device. The tire pressure sensor can generate signals based on tire pressure and transmits the signal to the actuator. The detection unit and central processing unit determine if the tire pressure normal, and transmit the result to the indication device. The driver in the car knows the tire pressure status by seeing the indication device. As the wireless co-sensing and co-vibrating tire pressure detecting device is located inside the tire, every time the tire is changed, the detecting device has to be removed from the tire and to install in the new tire. It is a cumbersome work. Moreover the detecting device needs an external power supply and requires wiring to the car battery. The whole construction becomes very complicated.

### SUMMARY OF THE INVENTION

In view of aforesaid disadvantages, it is therefore an object of this invention to provide an improved automatic car tire pressure detecting apparatus that has a self-generating power supply and does not need external electric power supply to transmit signals.

To attain aforesaid object, this invention provides an emission means located at the inner side of the wheel rim and a receiving means located at the brake pad. The emission means includes a generator, an emission end and a pressure sensor. The generator has a coil which has a positive and a negative end linked in series with a rectify switch and the emission end. The receiving means includes a magnet located at a corresponding tangent spot of the coil, a receiving end and a microprocessor attached to a display device.

### BRIEF DESCRIPTION OF THE DRAWINGS

The invention, as well as its many advantages, may be further understood by the following detailed description and drawings, in which:

FIG. 1 is a schematic view of signal transmission of this invention.

FIG. 2 is a schematic front view of this invention in use.

FIG. 3 is a schematic view of this invention deployed in a car.

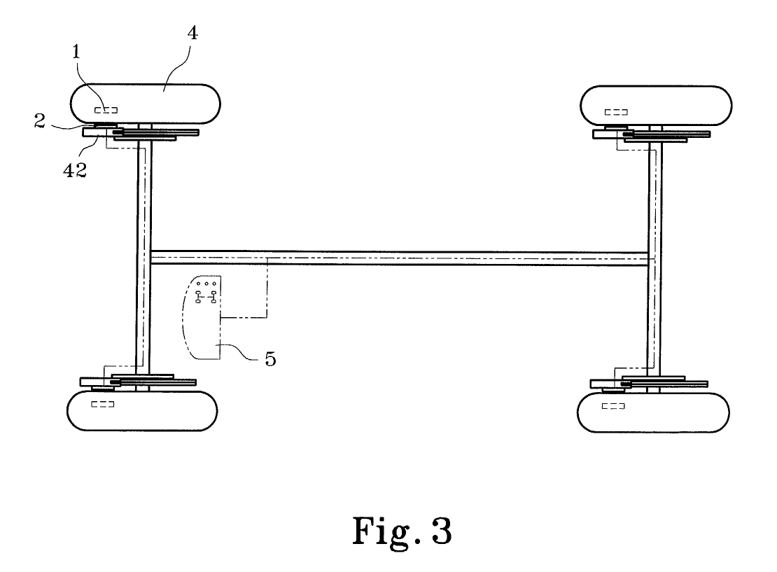

FIG. 4 is a schematic view of magnetic induction generating electricity according to this invention.

FIG. 5 is a fragmentary sectional view of this invention.

### DETAILED DESCRIPTION OF THE PREFERRED EMBODIMENT

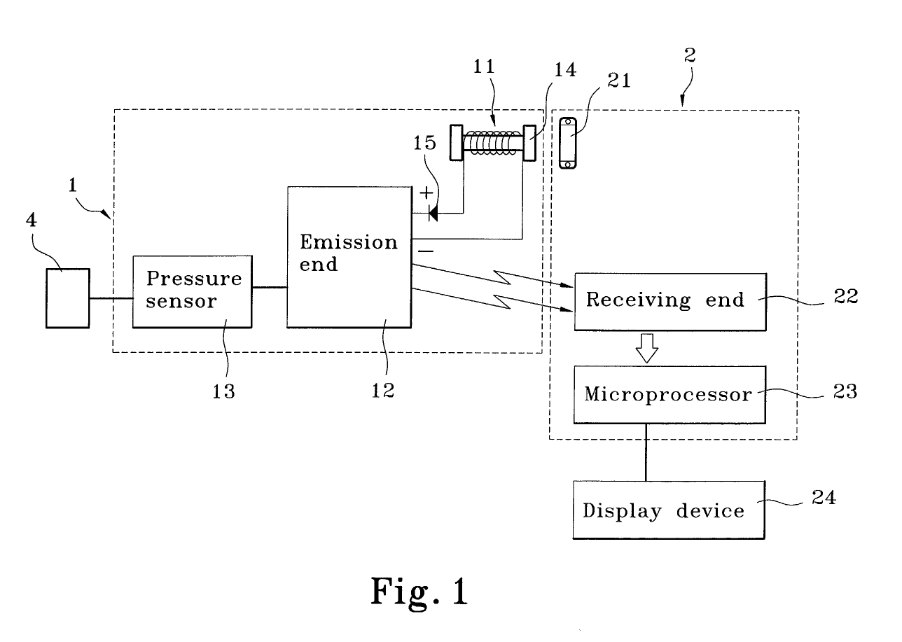

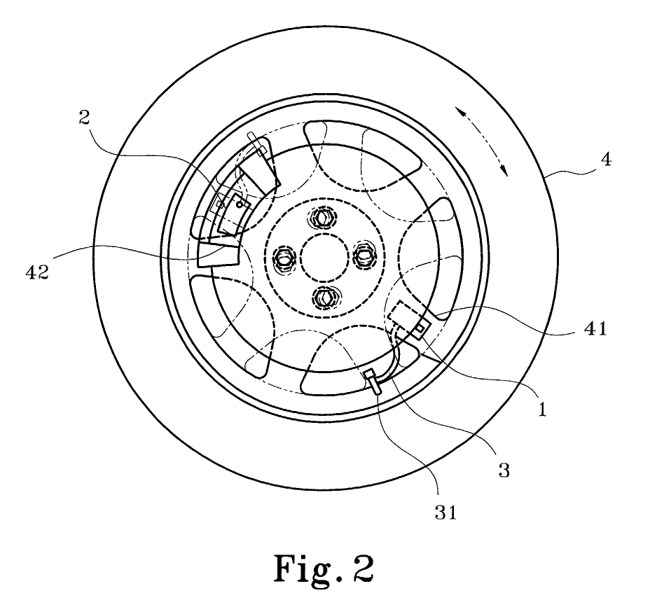

Referring to FIGS. 1 and 2, the tire pressure detecting apparatus according to this invention is located at the wheel rim 41 of a tire 4 and brake pad 42, and constitutes an emission means 1 and a receiving means 2.

The emission means 1 is mounted at the inner side of the wheel rim 41 and is engaged with the inflation valve 43 of the tire 4. The emission means 1 constitutes a generator 11 linking to an emission end 12 and a pressure sensor 13 linking to an air tube 3. The air tube 3 has a connector 31. The generator 11 includes a coil 14 which has a positive end and a negative end connected in series with a rectify switch 15 and the emission end 12. The rectify switch 15 is a diode or other equivalent element which has an electric level difference for rectifying if the current flowing therethrough is positive. The emission end 12 may be a wireless transmission interface. The emission means 1 is sealed in a casing.

The receiving means 2 is mounted on the brake pad 42 and includes a magnet 21 located at a corresponding tangent spot of the coil 14, a receiving end 22 and a microprocessor 23 attached to a display device 24. The receiving end 22 may be a receiver. The display device 24 will display the determining result processed by the microprocessor 23. The display device 24 is wired to the dashboard 5 through the brake oil pipe. The receiving means 2 is also sealed in a casing.

When the tire 4 is rotating, the magnet 21 of the receiving means 2 continuously cuts through the coil 14 and generates electric current which in turn actuates the emission end 12 to emit signals which are received by the receiving end 22. The rectify switch 15 can distinguish if the current is positive. When it is positive current, the electric current generated by the coil 14 will actuate the emission end 12 thereby the tire pressure detecting apparatus can self-generate power supply to transmit signal without external power supply.

The pressure sensor 13 is a circuit known in the art, thus will be omitted herein. Only the novel features and function related to this invention will be elaborated hereunder. When the tire 4 rotates and the coil 14 continuously cuts through magnet 21 and generate electric current in the coil 14, the emission means 1 connected to the inflation valve 43 starts using the pressure sensor 13 to measure tire pressure. The tire pressure reading is transmitted to the emission end 12 through the pressure sensor 13. The current generated in the coil 14 actuates the emission end 12 and transmits the signals being recorded thereon. The emitting signals from the emission end 12 are received by the receiving means 2 located at the brake pad 42 and transferred to the microprocessor 23. After processed, the results are displayed to the display device 24 at the dashboard 5 so that driver may see the tire pressure when the car is moving.

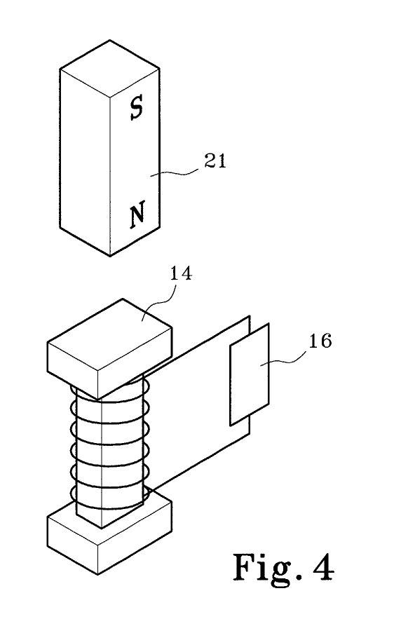

Referring to FIG. 4 for the principle of current generation and signal transmission of this invention. The generator 11 generates electric current and voltage through magnetic induction by employing Faraday's Law and generator principle. Current flow direction may be determined by Fleming's left hand principle. As shown in FIG. 1, when the magnet 21 moves and cuts through the coil 14, the coil 14 will generate electric current to the load 16 (FIG. 4). Hence by means of the electromagnetic induction, a basic power generating facility can be formed. Briefly speaking, power generation will be achieved by relative cutting motion taking place between the coil 14 and magnet 21, with the coil 14 cutting the magnetic flux of the magnet 21 to generate electric current.

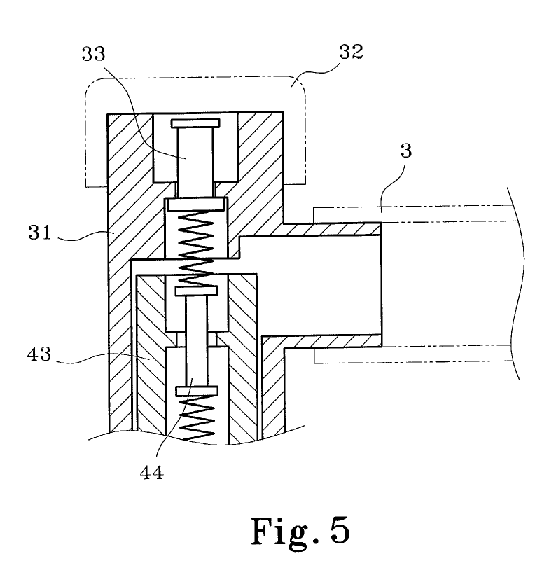

Referring to FIG. 5 for an embodiment of this invention, the air tube 3 has a connector 31 connecting with the inflation valve 43 of the tire 4. The inflation valve 43 includes an air inlet means 44. The connector 31 is a three-way connector and includes another air inlet means 33 which has similar construction as the inflation valve 43. Users may remove the cap 32 of the connector 31 to inflate the tire when desired.

It thus can be seen that the construction of this invention set forth above can effectively resolve the shortcomings of the conventional tire pressure detection devices, and offers drivers constant notice of tire pressure status to ensure more safely driving.

What is claimed is:

1. An automatic car tire pressure detecting apparatus being disposed at the wheel rim of a tire and a brake pad for detecting tire pressure, comprising:
an emission means mounted at an inner side of the wheel rim and engaged with an inflation valve of the tire having a generator which includes an emission end and a pressure sensor linking to an air tube, the generator having a coil which has a positive and negative end linking in series with a rectify switch and the emission end; and
a receiving means mounted on the brake pad including a magnet located at a tangent spot corresponding to the coil, a receiving end and a microprocessor attached to a display device;
wherein the tire rotates and causes the magnet continuously cutting the coil to generate electric current thereby generating electric current to actuate the emission end to emit signals which are received by the receiving end, the rectify switch determining if the current flowing therethrough is positive, the positive current being used for actuating the emission end such that the detecting apparatus is capable of providing self-generating power supply to transmit the signals without an external power supply.

2. The automatic car tire pressure detecting apparatus of claim 1, wherein the emission means and receiving means are sealed in a casing.

3. The automatic car tire pressure detecting apparatus of claim 1, wherein the emission end is a wireless transmission interface.

4. The automatic car tire pressure detecting apparatus of claim 1, wherein the air tube includes a three-way connector.

5. The automatic car tire pressure detecting apparatus of claim 1, wherein the rectify switch is a diode.

6. The automatic car tire pressure detecting apparatus of claim 1, wherein the receiving end is a receiver.

7. The automatic car tire pressure detecting apparatus of claim 1, wherein the display device is capable of displaying result determined by the microprocessor and is linked to the dashboard of the car through a brake oil pipe.
